(19) United States
(12) Patent Application Publication
(10) Pub. No.: US 2009/0002615 A1
(43) Pub. Date: Jan. 1, 2009

(54) DISPLAY DEVICE

(75) Inventors: Gen FUJII, Chigasaki (JP); Erika TAKAHASHI, Atsugi (JP)

Correspondence Address: FISH & RICHARDSON P.C., P.O. BOX 1022, MINNEAPOLIS, MN, 55440-1022, US

(73) Assignee: SEMICONDUCTOR ENERGY LABORATORY CO., LTD., Atsugi-shi (JP)

(21) Appl. No.: 12/137,703

(22) Filed: Jun. 12, 2008

(30) Foreign Application Priority Data
Jun. 15, 2007 (JP) 2007-159178

(51) Int. Cl. G02F 1/1337

(52) U.S. Cl. 349/123

(57) ABSTRACT

To manufacture display devices with improved image quality and reliability or display devices with a large screen at low cost with high productivity. An electrode layer containing a conductive polymer is used as an electrode layer of a display element in a display device and an inorganic insulating film serving as a passivation film is provided between the electrode layer and a display layer. Ionic impurities in the electrode layer are easily ionized and become mobile ions and thereby deteriorating a liquid crystal material or the like which is included in a display layer in a display element. Ionic impurities in the electrode layer are prevented from moving into a display layer by the inorganic insulating film. Thus, the reliability of the display device can be improved.

### TECHNICAL FIELD

The present invention relates to display devices including a display element which includes electrode layers.

### BACKGROUND ART

Conductive polymers are widely used as a conductive material or an optical material for various devices in the electrical and electronics industry because of their high processability. Novel conductive polymer materials are developed to improve conductivity and processability of a conductive polymer for practical application.

For example, an alkali metal, a halogen, or the like is added to a conductive polymer as a dopant in order to improve conductivity (for example, see Patent Document 1: Japanese Published Patent Application No. 2003-346575).

### DISCLOSURE OF INVENTION

However, there has been a problem such that if the above-described conductive polymer is used for an electrode layer in a display device or the like, high reliability cannot be obtained in the display device.

Therefore, it is an object of the present invention to manufacture display devices with improved image quality and reliability or display devices with a large screen at low cost with high productivity.

In a display device of the present invention, an electrode layer containing a conductive polymer is used as at least one of a pair of electrode layers in a display element which also includes a display layer, and an inorganic insulating film is provided between the electrode layer containing a conductive polymer and the display layer.

The inorganic insulating film serves as a barrier film (which is also referred to as a passivation film) against ionic impurities diffusing from the electrode layer containing a conductive polymer, which blocks ionic impurities moving from the electrode layer to the display layer in order to prevent contamination of the display layer. The ionic impurities refer to elements or compounds in the electrode layer containing a conductive polymer, which is ionized to be mobile ions.

The mobile ionic impurities move in the display device and deteriorate a liquid crystal material (or a light emitting material) or the like in the display layer which is formed over the electrode layer, thereby causing a display defect. If a large amount of such ionic impurities which are a contamination source generate, characteristics of the display device is deteriorated and the reliability is reduced. Accordingly, in the present invention, the inorganic insulating film stops the ionic impurities diffusing from the electrode layer containing a conductive polymer to the display layer and thereby preventing deterioration of the display layer.

The inorganic insulating film may be provided between the display layer and the electrode layer containing a conductive polymer. Preferably, the inorganic insulating film is provided in contact with the electrode layer containing a conductive polymer for higher barrier effect. The inorganic insulating film may be provided to cover the entire surface of the electrode layer containing a conductive polymer or may be provided selectively in a region which is in contact with the display layer.

A light transmitting nitride film (such as a silicon nitride film or a silicon nitride oxide film) can be used as the inorganic insulating film. The film thickness is determined so that the thickness is equal to or greater than the thickness with which the barrier effect can be exerted and the thickness is equal to or less than the thickness with which voltage application to the display layer is not blocked. For example, the film thickness is preferably equal to or greater than 5 nm and equal to or less than 500 nm. The inorganic insulating film can be a dense film and have high barrier function when formed by a dry process (a sputtering method, an evaporation method, a physical vapor deposition (PVD) method, or a chemical vapor deposition (CVD) method such as a low pressure CVD (LPCVD) method or a plasma CVD method).

As the inorganic insulating film, silicon oxide, silicon nitride, silicon oxynitride, silicon nitride oxide, or the like can be used as a single layer or a laminate of, for example, two or three layers. Note that in this specification, silicon oxynitride refers to a substance which contains more oxygen than nitrogen, and can also be referred to as silicon oxide containing nitrogen. In the same manner, silicon nitride oxide refers to a substance which contains more nitrogen than oxygen, and can also be referred to as silicon nitride containing oxygen.

Further, the inorganic insulating film may be formed of a substance selected from aluminum nitride, aluminum oxynitride containing more oxygen than nitrogen, aluminum nitride oxide containing more nitrogen than oxygen, aluminum oxide, diamond-like carbon (DLC), nitrogen-containing carbon, or other substances containing an inorganic insulating material.

As the conductive polymer, a so-called π electron conjugated conductive polymer can be used. For example, polyaniline and/or a derivative thereof, polypyrrole and/or a derivative thereof, polythiophene and/or a derivative thereof, and a copolymer of two or more of those materials can be given.

Specific examples of the conjugated polymer are given below: polypyrrole, poly(3-methylpyrrole), poly(3-butylpyrrole), poly(3-octylpyrrole), poly(3-decylpyrrole), poly(3,4-dimethylpyrrole), poly(3,4-dibutylpyrrole), poly(3-hydroxypyrrole), poly(3-methyl-4-hydroxypyrrole), poly(3-methoxypyrrole), poly(3-ethoxypyrrole), poly(3-octoxypyrrole), poly(3-carboxylpyrrole), poly(3-methyl-4-carboxylpyrrole), poly(N-methylpyrrole), polythiophene, poly(3-methylthiophene), poly(3-butylthiophene), poly(3-octylthiophene), poly(3-decylthiophene), poly(3-dodecylthiophene), poly(3-methoxythiophene), poly(3-ethoxythiophene), poly(3-octoxythiophene), poly(3-carboxylthiophene), poly(3-methyl-4-carboxylthiophene), poly(3,4-ethylenedioxythiophene), polyaniline, poly(2-methylaniline), poly(2-octylaniline), poly(2-isobutylaniline), poly(3-isobutylaniline), poly(2-anilinesulfonic acid), or poly(3-anilinesulfonic acid).

An organic resin or a dopant may be added to the electrode layer containing a conductive polymer. When an organic resin is added, characteristics of the film, such as film strength and the shape can be adjusted and a film with a favorable shape can be formed. When a dopant is added, the electrical conductivity of the film can be adjusted and the conductivity can be improved.

The organic resin which is added to the electrode layer containing a conductive polymer may be a thermosetting resin, a thermoplastic resin, or a photocurable resin as long as the organic resin is compatible with the conductive polymer or the organic resin can be mixed and dispersed into the conductive polymer. For example, a polyester-based resin such as poly(ethylene terephthalate), poly(butylene terephthalate), or poly(ethylene naphthalate); a polyimide-based resin such as polyimide or polyamide imide; a polyamide resin such as polyamide 6, polyamide 66, polyamide 12, or polyamide 11; a fluorine resin such as poly(vinylidene fluoride), poly(vinyl fluoride), polytetrafluoroethylene, ethylene-tetrafluoroethylene copolymer, or polychlorotrifluoroethylene; a vinyl resin such as poly(vinyl alcohol), poly(vinyl ether), poly(vinyl butyral), poly(vinyl acetate), or polyvinylchloride; an epoxy resin; a xylene resin; an aramid resin; a polyurethane-based resin; a polyurea-based resin; a melamine resin; a phenol-based resin; polyether; an acrylic-based resin; or a copolymer thereof can be used.

Among examples of a dopant which is added to the electrode layer containing a conductive polymer, a halogen, a Lewis acid, an inorganic acid, an organic acid, a halide of a transition metal, an organic cyano compound, and a nonionic surfactant or the like can be used particularly as an acceptor dopant.

As examples of a halogen, iodine (I₂), bromine (Br₂), chlorine (Cl₂), iodine chloride (ICl), iodine trichloride (ICl₃), iodine bromide (IBr), and iodine fluoride (IF) can be given. As examples of a Lewis acid, phosphorus pentafluoride, arsenic pentafluoride, antimony pentafluoride, boron trifluoride, boron trichloride, and boron tribromide can be given. As examples of an organic acid, an organic carboxylic acid, an organic sulfonic acid, and phenol can be given. As examples of an organic carboxylic acid, acetic acid, benzoic acid, and phthalic acid can be given. As examples of an organic sulfonic acid, p-toluenesulfonic acid, naphthalenesulfonic acid, alkyl naphthalene sulfonic acid, anthraquinonesulfonic acid, and dodecylbenzene sulfonate, can be given. As examples of a halide of a transition metal, iron chloride (FeCl₃), molybdenum chloride (MoCl₅), tungsten chloride (WCl₅), tin chloride (SnCl₄), molybdenum fluoride (MoF₅), ferric oxychloride (FeOCl), ruthenium fluoride (RuF₅), tantalum bromide (TaBr₅), and tin iodide (SnI₄) can be given. As examples of an organic cyano compound, a compound having two or more cyano groups in a conjugated bonding can be given, such as tetracyanoethylene, tetracyanoethylene oxide, tetracyanobenzene, tetracyanoquinodimethane, and tetracyanoazanaphthalene.

Among examples of a dopant which is added to the electrode layer containing a conductive polymer, an alkali metal, an alkaline earth metal, and a tertiary amine compound (tetraethylammonium or tetrabutylammonium) or the like can be used particularly as a donor dopant. As examples of an alkali metal, lithium (Li), sodium (Na), potassium (K), cesium (Cs), and rubidium (Rb) are given. As examples of an alkaline earth metal, calcium (Ca), strontium (Sr), and barium (Ba) are given.

Although the above-described alkali metal, alkaline earth metal, an element such as a halogen, and an inorganic acid may form ionic impurities if they are ionized and move from the electrode layer containing a conductive polymer in the display device, such ionic impurities can be prevented from moving and diffusing into the display layer in the present invention because the inorganic insulating film is provided as a barrier film against the electrode layer containing a conductive polymer.

Further, an element or compound in the electrode layer containing a conductive polymer, which may become ionic impurities may be reduced (preferably, the concentration is equal to or less than 1000 ppm). The concentration of an element or compound in the electrode layer containing a conductive polymer can be reduced (preferably, the concentration is equal to or less than 1000 ppm) by manufacturing the electrode layer containing a conductive polymer using a conductive composition containing a conductive polymer in which ionic impurities are reduced by purification or the like.

Ionic impurities are impurities which easily form ions by ionization or dissociation and easily move. Accordingly, if ionic impurities are cations, the ionic impurities may be an element with a small ionization energy (e.g., equal to or less than 6 eV). An element with such a small ionization energy is, for example, lithium (Li), sodium (Na), potassium (K), cesium (Cs), rubidium (Rb), strontium (Sr), or barium (Ba).

If ionic impurities are anions, the ionic impurities may be an anion such as a halogen ion included in an inorganic acid. For example, a substance having a pKₐ value, which is a negative decimal logarithm of an acid dissociation constant Kₐ, of equal to or less than 4 easily dissociates and easily becomes an ion. Note that in this specification, pKₐ, which is a negative decimal logarithm of acid dissociation constant Kₐ, is a pKₐ value of the substance in an infinite dilute solution at 25° C. Fluorine (F⁻), chlorine (Cl⁻), bromine (Br⁻), iodine (I⁻), SO₄²⁻, HSO₄⁻, ClO₄⁻, NO₃⁻, or the like can be given as the above-described anion.

Further, ions with small sizes (e.g., an ion which consists of 6 atoms or less) tend to have mobility and may move into a display layer to be ionic impurities.

When an electrode layer used in a display element of the present invention is a thin film, it preferably have a sheet resistance of equal to or less than 10000 Ω/square and a light transmittance of equal to or greater than 70% with respect to light having a wavelength of 550 nm. In addition, resistivity of a conductive polymer in the electrode layer is preferably equal to or less than 0.1 Ω·cm.

In this specification, electrode layers consisting a pair of electrode layers in the display element may also be referred to as a pixel electrode layer and a counter electrode layer depending on which substrate the electrode layer is provided over. In addition, one of the pair of electrode layers may also be referred to as a first electrode layer and the other may also be referred to as a second electrode layer. An electrode layer containing a conductive polymer according to the present invention may be used as at least one of the pair of electrode layers in the above-described display element. It is needless to say that both of the pair of electrode layers may use an electrode layer containing a conductive polymer according to the present invention. An inorganic insulating film is provided as a barrier film between an electrode layer containing a conductive polymer and a display layer. Accordingly, in this specification, a pixel electrode layer, a counter electrode layer, a first electrode layer, and a second electrode layer each refer to an electrode layer which is provided in a display element.

In the present invention, an electrode layer containing a conductive polymer is formed using a thin film manufactured by a wet process using a conductive composition containing a conductive polymer. An electrode layer containing a conductive polymer may additionally contain an organic resin, a dopant, or the like. In this case, an organic resin, a dopant, or the like is mixed into the conductive composition containing a conductive polymer, which is a material of the electrode layer containing a conductive polymer. In this specification, a conductive composition refers to a material for forming an electrode layer, the material containing at least a conductive polymer, which optionally includes an organic resin, a dopant, or the like. In manufacture, an electrode layer is formed using a thin film which is formed by a wet process using a liquid composition in which a conductive composition is dissolved in a solvent.

As described above, the conductive composition containing a conductive polymer can be formed into a thin film by being dissolved in a solvent and subjected to a wet process as a liquid composition. In a wet process, a material of a thin film is dissolved in a solvent, the resulting liquid composition is applied to a region where the film is to be formed, then the solvent is removed and solidification is performed; thus a thin film is formed. In this specification, solidification refers to elimination of fluidity to keep a fixed shape.

For a wet process, any of the following methods can be employed: a spin coating method, a roll coating method, a spray method, a casting method, a dipping method, a droplet discharge (ejection) method (an inkjet method), a dispenser method, a variety of printing methods (a method by which a film can be formed in a desired pattern, such as screen (mimeograph) printing, offset (planographic) printing, letterpress printing, or gravure (intaglio) printing), or the like. Note that a method for forming a film of a liquid composition of the present invention is not limited to the above-described methods and any method in which a liquid composition is used can be employed.

In a wet process, a material is not scattered in a chamber, and therefore, efficiency in the use of materials is high compared with a dry process such as an evaporation method or a sputtering method. Further, since film formation can be performed at atmospheric pressure, facilities such as a vacuum apparatus and the like can be reduced. Furthermore, since the size of a substrate which is processed is not limited by the size of a vacuum chamber, it is possible to use a larger substrate, whereby low cost and improvement in productivity can be achieved. Heat treatment needed in a wet process is performed at a temperature at which a solvent of a composition can be removed, and therefore, a wet process is a so-called low temperature process. Accordingly, even a substrate and a material which may degrade or deteriorate by heat treatment at a high temperature can be used.

Since a liquid composition having fluidity is used for the formation, materials can be easily mixed. For example, conductivity or processability can be improved by addition of an organic resin or a dopant to the composition. In addition, good coverage with respect to a region where a thin film of the composition is formed can also be achieved.

A thin film can be selectively formed by a droplet discharge method in which a composition can be discharged to form a desired pattern, a printing method in which a composition can be transferred or drawn into a desired pattern, and the like. Therefore, less material is wasted, and a material can be efficiently used; accordingly, a production cost can be reduced. Furthermore, such methods do not require processing of the shape of the thin film by a photolithography process, and therefore simplifies the process and improves the productivity.

An electrode layer which is formed using a conductive composition containing a conductive polymer of the present invention has an inorganic insulating film which blocks ionic impurities which contaminate a liquid crystal material or the like in a display layer, so that deterioration of the display layer is prevented. Therefore, a display device with high reliability can be manufactured using such an electrode layer.

Further, since a wet process can be employed for manufacturing an electrode layer of a display element, efficiency in the use of materials can be high. Still further, since expensive facilities such as a large vacuum apparatus can be reduced, a cost reduction and a productivity improvement can be achieved. Thus, according to the present invention, highly reliable display devices and electronic appliances can be manufactured at low cost with improved productivity.

One aspect of the present invention is a display device including a display element which has a pair of electrode layers and a display layer, in which at least one of the pair of electrode layers contains a conductive polymer, and an inorganic insulating film is provided between the electrode layer containing a conductive polymer and the display layer.

Another aspect of the present invention is a display device including a display element which has a pair of electrode layers and a display layer, in which each of the pair of electrode layers contains a conductive polymer, and an inorganic insulating film is provided between each of the pair of electrode layers containing a conductive polymer and a display layer.

In the above-described structure, in the case of using a liquid crystal element as the display element, the display layer is a liquid crystal layer and an insulating layer serving as an alignment film may be provided between the inorganic insulating film and the liquid crystal layer.

In this specification, a display device refers to a device which includes a display element. A display device also refers to a display panel itself in which a plurality of pixels including a display element and a peripheral driver circuit for driving the pixels are formed over a substrate. Further, a display device may include a Flexible printed circuit (FPC), a printed wiring board (PWB), an IC, a resistor, a capacitor, an inductor, a transistor, or the like. Further, a display device may include an optical sheet such as a polarizing plate or a retardation plate. Further, a display device may include a backlight (which may include a light guide plate, a prism sheet, a diffusion sheet, a reflective sheet, or a light source (e.g., an LED or a cold cathode fluorescent lamp)).

A structure of the present invention is remarkably effective in a display element such as a liquid crystal display element, in which characteristics of a display layer deteriorate by ionic impurities. Accordingly, the structure of the present invention is preferably used in such a display element. The present invention can also be applied to an electroluminescent (EL) element or a display medium such as electronic ink, in which contrast is changed by an electrical action. Note that a display device using a liquid crystal element refers to a liquid crystal display, a transmissive liquid crystal display, a transflective liquid crystal display, or a reflective liquid crystal display. A display device using electronic ink may refer to an electronic paper.

An electrode layer formed using a conductive composition containing a conductive polymer of the present invention, which is used for a display element, has an inorganic insulating film which blocks ionic impurities which contaminate a liquid crystal material or the like in a display layer, so that deterioration of the display layer is prevented. Therefore, a display device with high reliability can be manufactured using such an electrode layer.

Further, since a wet process can be employed for manufacturing an electrode layer of a display element, efficiency in the use of materials can be high, and a cost reduction and a productivity improvement can be achieved because expensive facilities such as a large vacuum apparatus can be reduced. Thus, according to the present invention, highly functional and highly reliable display devices and electronic appliances can be manufactured at low cost with improved productivity.

### BRIEF DESCRIPTION OF DRAWINGS

FIGS. 1A and 1B are cross-sectional views of a display device of the present invention;

FIG. 2 is a cross-sectional view of a display device of the present invention;

FIG. 3 is a droplet discharge apparatus which can be used in a manufacturing process of a display device of the present invention;

FIGS. 4A and 4B are a plan view and a cross-sectional view of a display device of the present invention;

FIG. 5 is a cross-sectional view of a display device of the present invention;

FIGS. 6A and 6B show cross-sectional views of display modules of the present invention;

FIGS. 7A to 7F show electronic appliances of the present invention;

FIGS. 8A to 8C show plan views of display devices of the present invention;

FIGS. 9A and 9B show plan views of display devices of the present invention;

FIG. 10 shows a block diagram of a main structure of an electronic appliance to which the present invention is applied; and

FIGS. 11A and 11B show electronic appliances of the present invention.

### BEST MODE FOR CARRYING OUT THE INVENTION

Embodiment modes are hereinafter described with reference to the drawings. However, it will be readily appreciated by those who skilled in the art that modes and details can be modified in various ways without departing from the spirit and the scope of the present invention. Accordingly, the present invention should not be construed as being limited to the description of the embodiment modes to be given below. Note that like portions in the drawings may be denoted by the like reference numerals and repeated description of such portions is omitted.

### Embodiment Mode 1

This embodiment mode will describe an example of a display device aimed at higher image quality and higher reliability, which can be manufactured at low cost with high productivity. Specifically, this embodiment mode will describe a display device having a passive-matrix structure.

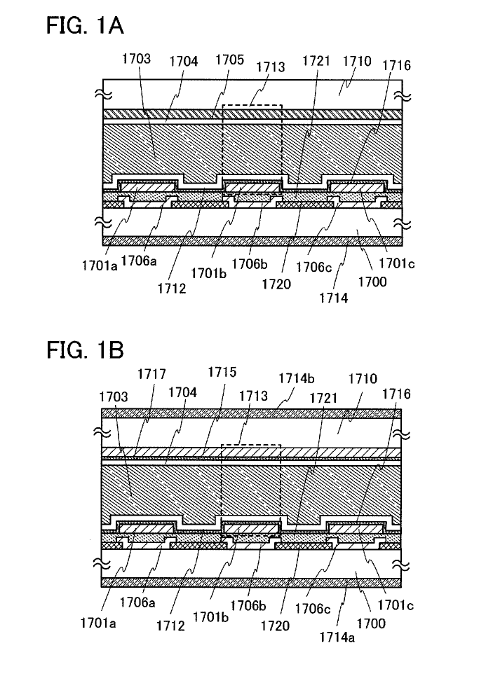

FIGS. 1A and 1B each show a passive matrix liquid crystal display device to which the present invention is applied. FIG. 1A shows a reflective liquid crystal display device and FIG. 1B shows a transmissive liquid crystal display device. In FIGS. 1A and 1B, a substrate 1700 and a substrate 1710 face each other with a liquid crystal layer 1703 sandwiched therebetween. In FIG. 1A, electrode layers 1701a, 1701b, and 1701c also referred to as pixel electrode layers, which are used for display elements 1713, an inorganic insulating film 1716, an insulating layer 1712 serving as an alignment film, color layers 1706a, 1706b, and 1706c serving as color filters, a light blocking layer 1720, an insulating layer 1721, and a polarizing plate 1714 are provided with the substrate 1700; and an insulating layer 1704 serving as an alignment film, and an electrode layer 1705 are provided with the substrate 1710. In FIG. 1B, electrode layers 1701a, 1701b, and 1701c also referred to as pixel electrode layers, which are used for display elements 1713, an inorganic insulating film 1716, an insulating layer 1712 serving as an alignment film, color layers 1706a, 1706b, and 1706c serving as color filters, a light blocking layer 1720, an insulating layer 1721, and a polarizing plate 1714a are provided with the substrate 1700; and an insulating layer 1704 serving as an alignment film, an electrode layer 1715, and a polarizing plate 1714b are provided with the substrate 1710.

FIG. 1A shows an example in which an electrode layer containing a conductive polymer is used as the electrode layers 1701a, 1701b, and 1701c. The inorganic insulating film 1716 is provided over the electrode layers 1701a, 1701b, and 1701c containing a conductive polymer as a barrier film. The inorganic insulating film 1716 is provided between the electrode layers 1701a, 1701b, and 1701c containing a conductive polymer, and the liquid crystal layer 1703 which is a display layer; therefore, ionic impurities can be prevented from diffusing into the liquid crystal layer 1703.

In the case of extracting light outside a display device through an electrode layer, the electrode layer of the display element is formed using a material having a light transmitting property with respect to the light. For example, in a transmissive liquid crystal display device or a dual emission light emitting display device, a light transmitting material is used for each of a pair of electrode layers. Since an electrode layer containing a conductive polymer according to the present invention has a light transmitting with respect to visible light, it can be used for both of the pair of electrode layers. Note that an electrode layer containing a conductive polymer according to the present invention may be used for one of the pair of electrode layers, and another light transmitting conductive material may be used for the other one of the pair of electrode layers.

As another light transmitting conductive material, indium tin oxide (ITO), indium zinc oxide (IZO), indium tin oxide to which silicon oxide is added (ITSO), indium oxide including tungsten oxide, indium zinc oxide including tungsten oxide, indium oxide including titanium oxide, indium tin oxide including titanium oxide, or the like can be used.

In a reflective liquid crystal display device and in a single-surface light emission display device, a reflective electrode layer may be used as one of a pair of electrode layers, which does not transmit light. As an alternative to a reflective electrode layer in a display element, another reflective film may be additionally provided.

As a conductive material having reflectivity, an element selected from titanium (Ti), nickel (Ni), tungsten (W), chromium (Cr), platinum (Pt), zinc (Zn), tin (Sn), indium (In), tantalum (Ta), aluminium (Al), copper (Cu), gold (Au), silver (Ag), magnesium (Mg), calcium (Ca), lithium (Li), and molybdenum (Mo); an alloy material containing any of the foregoing elements as its main component, such as titanium nitride, TiSi_{X}N_{Y}, WSi_{X}, tungsten nitride, WSi_{X}N_{Y}, NbN, or the like; or a compound material can be used.

A thin film which is to be an electrode layer can be formed using any of the foregoing conductive materials by a sputtering method, an evaporation method, a PVD method, a CVD method, a spin coating method, a roll coating method, a spray method, a casting method, a dipping method, a droplet discharge (ejection) method (an inkjet method), a dispenser method, a printing method, or the like.

Since the display device in FIG. 1A is a reflective liquid crystal display device, the electrode layer 1705 necessarily has reflectivity. In this case, a conductive film formed of any of the foregoing conductive materials having reflectivity may be used, or a laminate of the conductive film and the electrode layer containing a conductive polymer may be used.

Further, as shown in FIG. 1B, electrode layers containing a conductive polymer may be used for each electrode of the pairs of electrode layers 1701a, 1701b, and 1701c, and the electrode layer 1715 which are used for the display elements. The inorganic insulating film 1716 is provided between the electrode layers 1701a, 1701b, and 1701c, which are electrode layers containing a conductive polymer, and the liquid crystal layer 1703; and an inorganic insulating film 1717 is provided between the electrode layer 1715, which is an electrode layer containing a conductive polymer, and the liquid crystal layer 1703; therefore, ionic impurities can be prevented from diffusing into the liquid crystal layer. Since the display device in FIG. 1B is a transmissive liquid crystal display device, a light transmitting electrode layer containing a conductive polymer is used for each electrode of the pairs of electrode layers 1701a, 1701b, and 1701c, and the electrode layer 1715, and polarizing plates 1714a and 1714b are used.

Mobile ionic impurities move in the display device and deteriorate a liquid crystal material or the like which is formed over the electrode layer, thereby causing a display defect. If a large amount of such ionic impurities which are a contamination source generate, characteristics of the display device is deteriorated and the reliability is reduced. Accordingly, in the present invention, the inorganic insulating film stops the ionic impurities diffusing from the electrode layer containing a conductive polymer to the display layer and thereby preventing deterioration of the display layer.

The inorganic insulating film may be provided between the display layer and the electrode layer containing a conductive polymer. Preferably, the inorganic insulating film is provided in contact with the electrode layer containing a conductive polymer for higher barrier effect. The inorganic insulating film may be provided to cover the entire surface of the electrode layer containing a conductive polymer or may be provided selectively in a region which is in contact with the display layer.

A light transmitting nitride film can be used as the inorganic insulating film. The film thickness is determined so that the thickness is equal to or greater than the thickness with which the barrier effect can be exerted and the thickness is equal to or less than the thickness with which voltage application to the display layer is not blocked. For example, the film thickness is preferably equal to or greater than 5 nm and equal to or less than 500 nm. The inorganic insulating film can be a dense film and have high barrier function when formed by a dry process (a sputtering method, an evaporation method, a physical vapor deposition (PVD) method, or a chemical vapor deposition (CVD) method such as a low pressure CVD (LPCVD) method or a plasma CVD method).

As the inorganic insulating film, silicon oxide, silicon nitride, silicon oxynitride, silicon nitride oxide, or the like can be used as a single layer or a laminate of, for example, two or three layers. Note that in this specification, silicon oxynitride refers to a substance which contains more oxygen than nitrogen, and can also be referred to as silicon oxide containing nitrogen. In the same manner, silicon nitride oxide refers to a substance which contains more nitrogen than oxygen, and can also be referred to as silicon nitride containing oxygen.

Further, the inorganic insulating film may be formed of a substance selected from aluminum nitride, aluminum oxynitride containing more oxygen than nitrogen, aluminum nitride oxide containing more nitrogen than oxygen, aluminum oxide, diamond-like carbon (DLC), nitrogen-containing carbon, or other substances containing an inorganic insulating material.

As the conductive polymer, a so-called π electron conjugated conductive polymer can be used. For example, polyaniline and/or a derivative thereof, polypyrrole and/or a derivative thereof, polythiophene and/or a derivative thereof, and a copolymer of two or more of those materials can be given.

Specific examples of the conjugated polymer are given below: polypyrrole, poly(3-methylpyrrole), poly(3-butylpyrrole), poly(3-octylpyrrole), poly(3-decylpyrrole), poly(3,4-dimethylpyrrole), poly(3,4-dibutylpyrrole), poly(3-hydroxypyrrole), poly(3-methyl-4-hydroxypyrrole), poly(3-methoxypyrrole), poly(3-ethoxypyrrole), poly(3-octoxypyrrole), poly(3-carboxylpyrrole), poly(3-methyl-4-carboxylpyrrole), poly(N-methylpyrrole), polythiophene, poly(3-methylthiophene), poly(3-butylthiophene), poly(3-octylthiophene), poly(3-decylthiophene), poly(3-dodecylthiophene), poly(3-methoxythiophene), poly(3-ethoxythiophene), poly(3-octoxythiophene), poly(3-carboxylthiophene), poly(3-methyl-4-carboxylthiophene), poly(3,4-ethylenedioxythiophene), polyaniline, poly(2-methylaniline), poly(2-octylaniline), poly(2-isobutylaniline), poly(3-isobutylaniline), poly(2-anilinesulfonic acid), or poly(3-anilinesulfonic acid).

An organic resin or a dopant may be added to the electrode layer containing a conductive polymer. When an organic resin is added, characteristics of the film, such as film strength and the shape can be adjusted and a film with a favorable shape can be formed. When a dopant is added, the electrical conductivity of the film can be adjusted and the conductivity can be improved.

The organic resin which is added to the electrode layer containing a conductive polymer may be a thermosetting resin, a thermoplastic resin, or a photocurable resin as long as the organic resin is compatible with the conductive polymer or the organic resin can be mixed and dispersed into the conductive polymer. For example, a polyester-based resin such as poly(ethylene terephthalate), poly(butylene terephthalate), or poly(ethylene naphthalate); a polyimide-based resin such as polyimide or polyamide imide; a polyamide resin such as polyamide 6, polyamide 66, polyamide 12, or polyamide 11; a fluorine resin such as poly(vinylidene fluoride), poly(vinyl fluoride), polytetrafluoroethylene, ethylene-tetrafluoroethylene copolymer, or polychlorotrifluoroethylene; a vinyl resin such as poly(vinyl alcohol), poly(vinyl ether), poly(vinyl butyral), poly(vinyl acetate), or polyvinylchloride; an epoxy resin; a xylene resin; an aramid resin; a polyurethane-based resin; a polyurea-based resin; a melamine resin; a phenol-based resin; polyether; an acrylic-based resin; or a copolymer thereof can be used.

Among examples of a dopant which is added to the electrode layer containing a conductive polymer, a halogen, a Lewis acid, an inorganic acid, an organic acid, a halide of a transition metal, an organic cyano compound, and a nonionic surfactant or the like can be used particularly as an acceptor dopant.

As examples of a halogen, iodine (I₂), bromine (Br₂), chlorine (Cl₂), iodine chloride (ICl), iodine trichloride (ICl₃), iodine bromide (IBr), and iodine fluoride (IF) can be given. As examples of a Lewis acid, phosphorus pentafluoride, arsenic pentafluoride, antimony pentafluoride, boron trifluoride, boron trichloride, and boron tribromide can be given. As examples of an organic acid, an organic carboxylic acid, an organic sulfonic acid, and phenol can be given. As examples of an organic carboxylic acid, acetic acid, benzoic acid, and phthalic acid can be given. As examples of an organic sulfonic acid, p-toluenesulfonic acid, naphthalenesulfonic acid, alkyl naphthalene sulfonic acid, anthraquinonesulfonic acid, and dodecylbenzene sulfonate, can be given. As examples of a halide of a transition metal, iron chloride (FeCl₃), molybdenum chloride (MoCl₅), tungsten chloride (WCl₅), tin chloride (SnCl₄), molybdenum fluoride (MoF₅), ferric oxychloride (FeOCl), ruthenium fluoride (RuF₅), tantalum bromide (TaBr₅), and tin iodide (SnI₄) can be given. As examples of an organic cyano compound, a compound having two or more cyano groups in a conjugated bonding can be given, such as tetracyanoethylene, tetracyanoethylene oxide, tetracyanobenzene, tetracyanoquinodimethane, and tetracyanoazanaphthalene.

Among examples of a dopant which is added to the electrode layer containing a conductive polymer, an alkali metal, an alkaline earth metal, and a tertiary amine compound (tetraethylammonium or tetrabutylammonium) or the like can be used particularly as a donor dopant. As examples of an alkali metal, lithium (Li), sodium (Na), potassium (K), cesium (Cs), and rubidium (Rb) are given. As examples of an alkaline earth metal, calcium (Ca), strontium (Sr), and barium (Ba) are given.

Although the above-described alkali metal, alkaline earth metal, an element such as a halogen, and an inorganic acid may form ionic impurities if they are ionized and move from the electrode layer containing a conductive polymer in the display device, such ionic impurities can be prevented from moving and diffusing into the display layer in the present invention because the inorganic insulating film is provided as a barrier film against the electrode layer containing a conductive polymer.

Further, an element or compound in the electrode layer containing a conductive polymer, which may become ionic impurities may be reduced (preferably, the concentration is equal to or less than 1000 ppm). The concentration of an element or compound in the electrode layer containing a conductive polymer can be reduced (preferably, the concentration is equal to or less than 1000 ppm) by manufacturing the electrode layer containing a conductive polymer using a conductive composition containing a conductive polymer in which ionic impurities are reduced by purification or the like.

Ionic impurities are impurities which easily form ions by ionization or dissociation and easily move. Accordingly, if ionic impurities are cations, the ionic impurities may be an element with such a small ionization energy (e.g., equal to or less than 6 eV). An element with such a small ionization energy is, for example, lithium (Li), sodium (Na), potassium (K), cesium (Cs), rubidium (Rb), strontium (Sr), or barium (Ba).

If ionic impurities are anions, the ionic impurities may be an anion such as a halogen ion included in an inorganic acid. For example, a substance having a pKₐ value, which is a negative decimal logarithm of an acid dissociation constant Kₐ, of equal to or less than 4 easily dissociates and easily becomes an ion. Note that in this specification, pKₐ, which is a negative decimal logarithm of acid dissociation constant Kₐ, is a pKₐ value of the substance in an infinite dilute solution at 25° C. Fluorine (F⁻), chlorine (Cl⁻), bromine (Br⁻), iodine (I⁻), SO₄²⁻, HSO₄⁻, ClO₄⁻, NO₃⁻, or the like can be given as the above-described anion.

Further, ions with small sizes (e.g., an ion which consists of 6 atoms or less) tend to have mobility and may move into a display layer to be ionic impurities.

When an electrode layer used in a display element of the present invention is a thin film, it preferably have a sheet resistance of equal to or less than 10000 Ω/square and a light transmittance of equal to or greater than 70% with respect to light having a wavelength of 550 nm. In addition, resistivity of a conductive polymer in the electrode layer is preferably equal to or less than 0.1 Ω·cm.

In this embodiment mode, an electrode layer containing a conductive polymer is formed using a thin film manufactured by a wet process using a conductive composition containing a conductive polymer. An electrode layer containing a conductive polymer may additionally contain an organic resin, a dopant, or the like. In this case, an organic resin, a dopant, or the like is mixed into the conductive composition containing a conductive polymer, which is a material of the electrode layer containing a conductive polymer. In this specification, a conductive composition refers to a material for forming an electrode layer, the material containing at least a conductive polymer, which optionally includes an organic resin, a dopant, or the like. In manufacture, an electrode layer is formed using a thin film which is formed by a wet process using a liquid composition in which a conductive composition is dissolved in a solvent.

Note that a conductive composition which is used for forming an electrode layer of the display element in this embodiment mode may be purified by a purification method to reduce ionic impurities in the resulting electrode layer containing a conductive polymer. The purification method may be selected from a variety of purification methods depending on the properties of a material such as an organic resin or a conductive polymer, which is contained in the conductive composition. For example, as the purification method, a reprecipitation method, a salting-out method, a column chromatography method (also referred to as a column method), or the like can be used. In particular, a column chromatography method is preferable. In a column chromatography method, a cylindrical receptacle is filled with a filler, and a solvent in which a reaction mixture is dissolved is poured thereinto; thus, impurities can be separated utilizing difference of affinity with the filler or the size of molecules between compounds. As a column chromatography method, an ion exchange chromatography method, a silica gel column chromatography method, a gel permeation chromatography (GPC) method, a high performance liquid chromatography (HPLC) method, or the like can be used. In an ion exchange chromatography method, an ion exchange resin is used as a stationary phase, and a substance to be ionized into ions is separated into parts utilizing difference in electrostatic adhesion to ion exchanger.

As described above, the conductive composition containing a conductive polymer can be formed into a thin film by being dissolved in a solvent and subjected to a wet process as a liquid composition. The solvent may be dried by heat or may be dried under reduced pressure. When the organic resin is a thermosetting resin, further heat treatment may be performed. When the organic resin is a photocurable resin, light irradiation treatment may be performed.

For a wet process, any of the following methods can be employed: a spin coating method, a roll coating method, a spray method, a casting method, a dipping method, a droplet discharge (ejection) method (an inkjet method), a dispenser method, a variety of printing methods (a method by which a film can be formed in a desired pattern, such as screen (mimeograph) printing, offset (planographic) printing, letterpress printing, or gravure (intaglio) printing), or the like. Alternatively, an imprinting technique or a nanoimprinting technique with which a nanoscale three-dimensional structure can be formed using a transfer technology can be employed. Imprinting and nanoimprinting are techniques with which a minute three-dimensional structure can be formed without using a photolithography process. Note that a method for forming a film of a liquid composition in this embodiment mode is not limited to the above-described methods and any method in which a liquid composition is used can be employed.

The liquid composition can be obtained by dissolving a conductive composition in water or an organic solvent (such as an alcohol-based solvent, a ketone-based solvent, an ester-based solvent, a hydrocarbon-based solvent, an aromatic-based solvent).

A solvent in which a conductive composition dissolves is not particularly limited. A solvent in which polymer resin compounds of the above-described conductive polymers and organic resins or the like dissolve may be used. For example, a conductive composition may be dissolved in any one of water, methanol, ethanol, ethylene glycol, propylene carbonate, N-methylpyrrolidone, dimethylformamide, dimethylacetamide, cyclohexanone, acetone, methyl ethyl ketone, methyl isobutyl ketone, and toluene, or a mixture thereof.

In a wet process, a material is not scattered in a chamber, and therefore, efficiency in the use of materials is high compared with a dry process such as an evaporation method or a sputtering method. Further, since film formation can be performed at atmospheric pressure, facilities such as a vacuum apparatus and the like can be reduced. Furthermore, since the size of a substrate which is processed is not limited by the size of a vacuum chamber, it is possible to use a larger substrate, whereby low cost and improvement in productivity can be achieved. Heat treatment needed in a wet process is performed at a temperature at which a solvent of a composition can be removed, and therefore, a wet process is a so-called low temperature process. Accordingly, even a substrate and a material which may degrade or deteriorate by heat treatment at a high temperature can be used.

Since a liquid composition having fluidity is used for the formation, materials can be easily mixed. For example, conductivity or processability can be improved by addition of an organic resin or a dopant to the composition. In addition, good coverage with respect to a region where a thin film of the composition is formed can also be achieved.

A thin film can be selectively formed by a droplet discharge method in which a composition can be discharged to form a desired pattern, a printing method in which a composition can be transferred or drawn into a desired pattern, and the like. Therefore, less material is wasted, and a material can be efficiently used; accordingly, a production cost can be reduced. Furthermore, such methods do not require processing of the shape of the thin film by a photolithography process, and therefore simplifies the process and improves the productivity.

An electrode layer which is formed using a conductive composition containing a conductive polymer in this embodiment mode has an inorganic insulating film which blocks ionic impurities which contaminate a liquid crystal material or the like in a display layer, so that deterioration of the display layer is prevented. Therefore, a display device with high reliability can be manufactured using such an electrode layer and an inorganic insulating film.

Further, since a wet process can be employed for manufacturing an electrode layer of a display element, efficiency in the use of materials can be high. Still further, since expensive facilities such as a large vacuum apparatus can be reduced, a cost reduction and a productivity improvement can be achieved. Thus, according to the present invention, highly reliable display devices and electronic appliances can be manufactured at low cost with improved productivity.

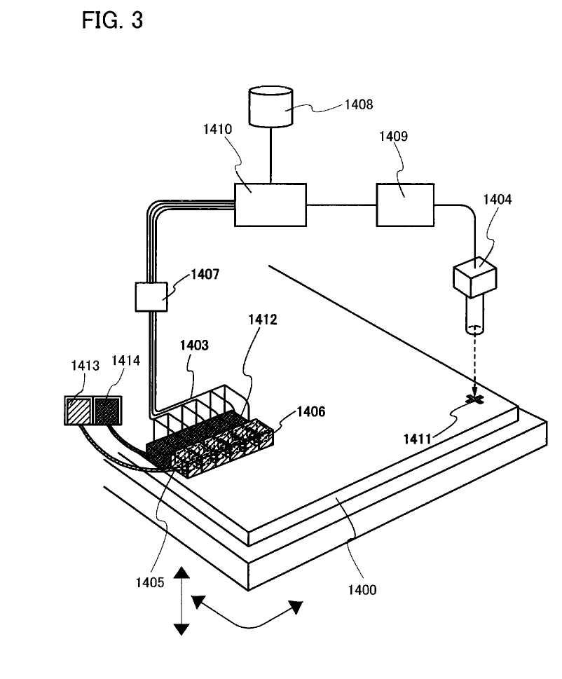

In a wet process, a droplet discharge means is used for example, which will be described with reference to FIG. 3. A droplet discharge means is a general term for an apparatus having means which discharges droplets, such as a nozzle having a discharge opening of a composition and a head having one or more nozzles.

FIG. 3 shows a mode of a droplet discharge apparatus used in a droplet discharge method. Each of heads 1405 and 1412 of a droplet discharge means 1403 is connected to a control means 1407, and this control means 1407 is controlled by a computer 1410, so that a preprogrammed pattern can be drawn. A position for drawing a pattern may be determined, for example, by determining a reference point by detecting a marker 1411 on a substrate 1400 using an imaging means 1404, an image processing means 1409, and the computer 1410. Alternatively, the reference point may be determined with reference to an edge of the substrate 1400.

As the imaging means 1404, an image sensor or the like using a charge coupled device (CCD) or a complementary metal oxide semiconductor (CMOS) can be used. Naturally, data on a pattern to be formed over the substrate 1400 is stored in a storage medium 1408, and a control signal is transmitted to the control means 1407 based on the data, so that each of the heads 1405 and 1412 of the droplet discharge means 1403 can be individually controlled. A discharged material is supplied to the heads 1405 and 1412 through pipes from a material source 1413 and a material source 1414, respectively.

Inside the head 1405, there are a space filled with a liquid material as indicated by dotted line 1406 and a nozzle serving as a discharge opening. Although not shown, the head 1412 has an internal structure similar to the head 1405. When the head 1405 and the head 1412 have nozzles with different sizes, patterns having different widths can be formed with different materials at the same. Thus, plural kinds of materials or the like can be discharged from one head to draw a pattern. When a pattern is drawn in a large area, the same material can be discharged at the same time through a plurality of nozzles to improve throughput. In the case of forming a pattern on a large substrate, the heads 1405 and 1412 and a stage provided with the substrate are scanned relatively in the direction of the arrows; thus, the area of the pattern can be set freely. Accordingly, a plurality of the same patterns can be drawn over one substrate.

Further, a step of discharging the composition may be performed under reduced pressure. The substrate may be heated when the composition is discharged. After the composition is discharged, either or both of steps of drying and baking are performed. Both the drying and baking steps are performed by heat treatment, but they have different purposes, temperatures, and time periods, for example, drying is performed for three minutes at 100° C. and baking is performed for 15 to 60 minutes at a temperature of 200 to 550° C. The steps of drying and baking are performed under normal pressure or under reduced pressure by laser irradiation, rapid thermal annealing, heating using a heating furnace, or the like. Note that the timing of the heat treatment and the number of heat treatment are not especially limited. The conditions for favorably perform the steps of drying and baking, such as temperature and time, depend on the material of the substrate and properties of the composition.

A glass substrate, a quartz substrate, or the like can be used as the substrates 1700 and 1710. Further, a flexible substrate may be used. A flexible substrate refers to a substrate which can be bent. For example, a polymer elastomer, which can be processed to be shaped as plastic by plasticization at high temperatures, and has a property of an elastic body like rubber at room temperature, or the like can be used in addition to a plastic substrate made of polycarbonate, polyarylate, polyethersulfone, or the like. Alternatively, a film (formed of polypropylene, polyester, vinyl, polyvinyl fluoride, vinyl chloride, or the like), an inorganic film formed by vapor deposition, or the like can be used.

A structure of the present invention is remarkably effective in a display element such as a liquid crystal display element, in which characteristics of a display layer deteriorate by ionic impurities. Accordingly, the structure of the present invention is preferably used in such a display element. Note that the present invention is not limited thereto and can also be applied to an electroluminescent (EL) element (which uses an electroluminescent layer containing an inorganic compound, or an inorganic compound and an organic compound as a display layer) or a display medium such as electronic ink, in which contrast is changed by an electrical action.

An electrode layer of a display element which is formed using a conductive composition containing a conductive polymer in this embodiment mode has an inorganic insulating film which blocks ionic impurities which contaminate a liquid crystal material or the like in a display layer, so that deterioration of the display layer is prevented. Therefore, a display device with high reliability can be manufactured using such an electrode layer and an inorganic insulating film.

Further, since a wet process can be employed for manufacturing an electrode layer of a display element, efficiency in the use of materials can be high, and a cost reduction and a productivity improvement can be achieved because expensive facilities such as a large vacuum apparatus can be reduced. Thus, according to the present invention, highly reliable display devices and electronic appliances can be manufactured at low cost with improved productivity.

### Embodiment Mode 2

This embodiment mode will describe an example of a display device aimed at higher image quality and higher reliability, which can be manufactured at low cost with high productivity. In this embodiment mode, a display device having a different structure from the above-described display device in Embodiment Mode 1 is described. Specifically, this embodiment mode will describe a display device having an active-matrix structure.

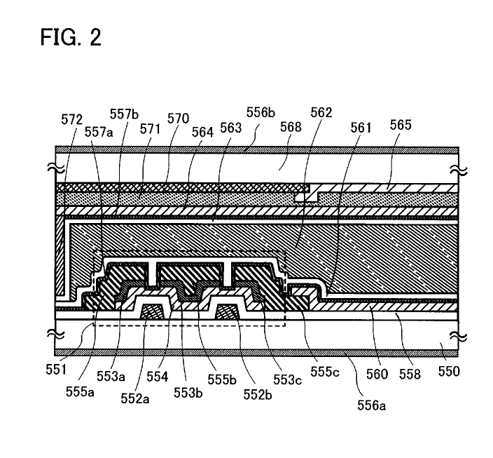

FIG. 2 shows an active matrix liquid crystal display device to which the present invention is applied. In FIG. 2, a substrate 550 provided with a transistor 551 having a multi-gate structure, an electrode layer 560 of a display element, an inorganic insulating film 557a, an insulating layer 561 serving as an alignment film, and a polarizer (also referred to as a polarizing plate) 556a; and a substrate 568 provided with an insulating layer 563 serving as an alignment film, an electrode layer 564 of a display element, an inorganic insulating film 557b, a color layer 565 serving as a color filter, a light blocking layer 570, an insulating layer 571, a spacer 572, a polarizer (also referred to as a polarizing plate) 556b face each other with a liquid crystal layer 562 sandwiched therebetween.

FIG. 2 shows a transmissive liquid crystal display device using an electrode layer containing a light transmitting conductive polymer as the electrode layer 560 and the electrode layer 564. The inorganic insulating film 557a is provided between the electrode layer 560 and the insulating layer 561 serving as an alignment film and the inorganic insulating film 557b is provided between the electrode layer 564 and the insulating layer 563 serving as an alignment film. The inorganic insulating film 557a and the inorganic insulating film 557b serve as barrier films which prevent ionic impurities from diffusing from the electrode layer 560 and the electrode layer 564.

The transistor 551 is an example of a multi-gate channel-etch inverted staggered transistor. In FIG. 2, the transistor 551 includes gate electrode layers 552a and 552b, a gate insulating layer 558, a semiconductor layer 554, semiconductor layers 553a, 553b, and 553c having one conductivity type, and wiring layers 555a, 555b, and 555c each serving as a source electrode layer or a drain electrode layer.

While FIG. 2 shows an example of a display device in which the polarizer 556b is outer than the substrate 568 (the viewer side) and the color layer 565 and the electrode layer 564 of a display element are inner than the substrate 568 and are provided in that order, the polarizer 556b may be inner than the substrate 568. Further, the stacked structure of the polarizer and the color layer is not limited to that shown in FIG. 2 and may be determined as appropriate depending on materials or conditions of a manufacturing process of the polarizer and of the color layer.

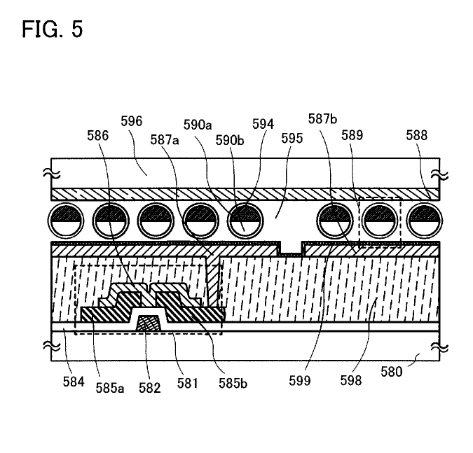

FIG. 5 shows an active matrix electronic paper to which the present invention is applied. While FIG. 5 shows an active matrix electronic paper, the present invention can also be applied to a passive matrix electronic paper.

An electronic paper in FIG. 5 is an example of a display device using a twisting ball display system. The twisting ball display system refers to a method in which spherical particles each colored in black and white are arranged between a first electrode layer and a second electrode layer, and a potential difference is generated between the first electrode layer and the second electrode layer to control orientation of the spherical particles, so that display is performed.

A transistor 581 is an inverted coplanar thin film transistor, and includes a gate electrode layer 582, a gate insulating layer 584, wiring layers 585a and 585b, and a semiconductor layer 586. In addition, the wiring layer 585b is electrically connected to a first electrode layer 587a through an opening formed in an insulating layer 598. Spherical particles 589 each including a black region 590a, a white region 590b, and a cavity 594 around the regions which is filled with liquid are provided between the first electrode layers 587a and 587b, and a second electrode layer 588. A space around the spherical particles 589 is filled with a filler 595 such as a resin (see FIG. 5).

In FIG. 5, an electrode layer containing a light transmitting conductive polymer is used as the first electrode layers 587a and 587b. The inorganic insulating film 599 is provided over the first electrode layers 587a and 587b. The inorganic insulating film 599 serves as a barrier film which prevents ionic impurities from diffusing from the first electrode layers 587a and 587b.

As an alternative to a twisting ball, an electrophoretic element can be used. A microcapsule having a diameter of approximately 10 to 200 μm is used in which a transparent liquid, positively charged white microparticles, and negatively charged black microparticles are encapsulated. In the microcapsule that is provided between the first electrode layer and the second electrode layer, when an electric field is applied by the first electrode layer and the second electrode layer, the white microparticles and the black microparticles move in opposite directions, so that white or black can be displayed. A display element using this principle is an electrophoretic display element, which is called an electronic paper in general. Since the electrophoretic display element has high reflectance compared with a liquid crystal display element, an auxiliary light is unnecessary, less power is consumed, and a display portion can be recognized even in a dim place. In addition, even when power is not supplied to the display portion, an image which has been displayed once can be maintained. Accordingly, a displayed image can be stored even if a semiconductor device having a display function (which may simply be referred to as a display device or a semiconductor device provided with a display device) is distanced from an electric wave source.

The electrode layer containing a conductive polymer and an inorganic insulating film serving as a barrier film according to the present invention in this embodiment mode can be manufactured using the same material and by the same process as Embodiment Mode 1; accordingly, Embodiment Mode 1 can be applied to the formation of the electrode layer and the inorganic insulating film in this embodiment mode.

Mobile ionic impurities move in the display device and deteriorate a liquid crystal material or the like which is formed over the electrode layer, thereby causing a display defect. If a large amount of such ionic impurities which are a contamination source generate, characteristics of the display device is deteriorated and the reliability is reduced. Accordingly, in the present invention, the inorganic insulating film stops the ionic impurities diffusing from the electrode layer containing a conductive polymer to the display layer and thereby preventing deterioration of the display layer.

The inorganic insulating film may be provided between the display layer and the electrode layer containing a conductive polymer. Preferably, the inorganic insulating film is provided in contact with the electrode layer containing a conductive polymer for higher barrier effect. The inorganic insulating film may be provided to cover the entire surface of the electrode layer containing a conductive polymer or may be provided selectively in a region which is in contact with the display layer.

A light transmitting nitride film can be used as the inorganic insulating film. The film thickness is determined so that the thickness is equal to or greater than the thickness with which the barrier effect can be exerted and the thickness is equal to or less than the thickness with which voltage application to the display layer is not blocked. For example, the film thickness is preferably equal to or greater than 5 nm and equal to or less than 500 nm. The inorganic insulating film can be a dense film and have high barrier function when formed by a dry process (a sputtering method, an evaporation method, a physical vapor deposition (PVD) method, or a chemical vapor deposition (CVD) method such as a low pressure CVD (LPCVD) method or a plasma CVD method).

As the inorganic insulating film, silicon oxide, silicon nitride, silicon oxynitride, silicon nitride oxide, or the like can be used as a single layer or a laminate of, for example, two or three layers. Note that in this specification, silicon oxynitride refers to a substance which contains more oxygen than nitrogen, and can also be referred to as silicon oxide containing nitrogen. In the same manner, silicon nitride oxide refers to a substance which contains more nitrogen than oxygen, and can also be referred to as silicon nitride containing oxygen.

Further, the inorganic insulating film may be formed of a substance selected from aluminum nitride, aluminum oxynitride containing more oxygen than nitrogen, aluminum nitride oxide containing more nitrogen than oxygen, aluminum oxide, diamond-like carbon (DLC), nitrogen-containing carbon, or other substances containing an inorganic insulating material.

As the conductive polymer, a so-called π electron conjugated conductive polymer can be used. For example, polyaniline and/or a derivative thereof, polypyrrole and/or a derivative thereof, polythiophene and/or a derivative thereof, and a copolymer of two or more of those materials can be given.

An organic resin or a dopant may be added to the electrode layer containing a conductive polymer. When an organic resin is added, characteristics of the film, such as film strength and the shape can be adjusted and a film with a favorable shape can be formed. When a dopant is added, the electrical conductivity of the film can be adjusted and the conductivity can be improved.

Among examples of a dopant which is added to the electrode layer containing a conductive polymer, a halogen, a Lewis acid, an inorganic acid, an organic acid, a halide of a transition metal, an organic cyano compound, and a nonionic surfactant or the like can be used particularly as an acceptor dopant.

Although the above-described alkali metal, alkaline earth metal, an element such as a halogen, and an inorganic acid may form ionic impurities if they are ionized and move from the electrode layer containing a conductive polymer in the display device, such ionic impurities can be prevented from moving and diffusing into the display layer in the present invention because the inorganic insulating film is provided as a barrier film against the electrode layer containing a conductive polymer.

Further, an element or compound in the electrode layer containing a conductive polymer, which may become ionic impurities may be reduced (preferably, the concentration is equal to or less than 1000 ppm). The concentration of an element or compound in the electrode layer containing a conductive polymer can be reduced (preferably, the concentration is equal to or less than 1000 ppm) by manufacturing the electrode layer containing a conductive polymer using a conductive composition containing a conductive polymer in which ionic impurities are reduced by purification or the like.

When an electrode layer used in a display element of the present invention is a thin film, it preferably have a sheet resistance of equal to or less than 10000 Ω/square and a light transmittance of equal to or greater than 70% with respect to light having a wavelength of 550 nm. In addition, resistivity of a conductive polymer in the electrode layer is preferably equal to or less than 0.1 Ω-cm.

As described above, the conductive composition containing a conductive polymer can be formed into a thin film by being dissolved in a solvent and subjected to a wet process as a liquid composition. The solvent may be dried by heat or may be dried under reduced pressure. When the organic resin is a thermosetting resin, further heat treatment may be performed. When the organic resin is a photocurable resin, light irradiation treatment may be performed.

The liquid composition can be obtained by dissolving a conductive composition in water or an organic solvent (such as an alcohol-based solvent, a ketone-based solvent, an ester-based solvent, a hydrocarbon-based solvent, an aromatic-based solvent). The solvent for dissolving the conductive composition is not particularly limited. A solvent which dissolves the above-described conductive polymer and polymer resin compound, may be used.

In a wet process, a material is not scattered in a chamber, and therefore, efficiency in the use of materials is high compared with a dry process such as an evaporation method or a sputtering method. Further, since film formation can be performed at atmospheric pressure, facilities such as a vacuum apparatus and the like can be reduced. Furthermore, since the size of a substrate which is processed is not limited by the size of a vacuum chamber, it is possible to use a larger substrate, whereby low cost and improvement in productivity can be achieved. Heat treatment needed in a wet process is performed at a temperature at which a solvent of a composition can be removed, and therefore, a wet process is a so-called low temperature process. Accordingly, even a substrate and a material which may degrade or deteriorate by heat treatment at a high temperature can be used.

A thin film can be selectively formed by a droplet discharge method in which a composition can be discharged to form a desired pattern, a printing method in which a composition can be transferred or drawn into a desired pattern, and the like. Therefore, less material is wasted, and a material can be efficiently used; accordingly, a production cost can be reduced. Furthermore, such methods do not require processing of the shape of the thin film by a photolithography process, and therefore simplifies the process and improves the productivity.

The semiconductor layer can be formed using the following material: an amorphous semiconductor (hereinafter also referred to as an “AS”) manufactured by a vapor deposition method using a semiconductor material gas typified by silane or germane or a sputtering method, a polycrystalline semiconductor formed by crystallizing an amorphous semiconductor utilizing light energy or thermal energy, a semiamorphous (also referred to as microcrystalline or microcrystal) semiconductor (hereinafter also referred to as a “SAS”), or the like. Alternatively, an organic semiconductor material may be used.

Typical examples of an amorphous semiconductor include hydrogenated amorphous silicon, and typical examples of a crystalline semiconductor include polysilicon and the like. Examples of polysilicon (polycrystalline silicon) include so-called high-temperature polysilicon that contains polysilicon as a main material and is formed at a process temperature greater than or equal to 800° C., so-called low-temperature polysilicon that contains polysilicon as a main material and is formed at a process temperature less than or equal to 600° C., and polysilicon obtained by crystallizing amorphous silicon using an element that promotes crystallization or the like. It is needless to say that a semiamorphous semiconductor or a semiconductor containing a crystal phase in part of a semiconductor film may also be used as described above. Further, a single crystal semiconductor may be used as the semiconductor layer, and a single crystal substrate or an SOI substrate provided with a single crystal semiconductor layer on an insulating surface may be used.

In the case of using a crystalline semiconductor film for the semiconductor layer, the crystalline semiconductor film may be formed by various methods (such as a laser crystallization method, a thermal crystallization method, or a thermal crystallization method using an element which promotes crystallization, such as nickel).

The semiconductor layer may be doped with a small amount of an impurity element (boron or phosphorus) in order to control the threshold voltage of thin film transistors.

The gate insulating layer is formed by a plasma CVD method, a sputtering method, or the like. The gate insulating layer may be formed using a material such as an oxide material or a nitride material of silicon, typified by silicon nitride, silicon oxide, silicon oxynitride, and silicon nitride oxide, and may be a stacked layer or a single layer.

The gate electrode layer, the source or drain electrode layer, and the wiring layer can be formed by forming a conductive film by a sputtering method, a PVD method, a CVD method, an evaporation method, or the like and then etching the conductive film into a desired shape. Alternatively, a conductive layer can be selectively formed in a predetermined position by a droplet discharge method, a printing method, a dispenser method, an electrolytic plating method, or the like. A reflow method or a damascene method may also be used. The source electrode layer or the drain electrode layer may be formed of a conductive material such as a metal; specifically, a material such as Ag, Au, Cu, Ni, Pt, Pd, Ir, Rh, W, Al, Cr, Nd, Ta, Mo, Cd, Zn, Fe, Ti, Zr, Ba, Si, or Ge, or an alloy or nitride thereof may be used. Alternatively, a stacked-layer structure of any of these materials may be used.

As the insulating layers 571 and 598, an inorganic insulating material such as silicon oxide, silicon nitride, silicon oxynitride, aluminum oxide, aluminum nitride, or aluminum oxynitride; acrylic acid, methacrylic acid, or a derivative thereof; a heat-resistant polymer such as polyimide, aromatic polyamide, or polybenzimidazole; or a siloxane resin may be used. Alternatively, a resin material such as a vinyl resin like polyvinyl alcohol or polyvinylbutyral, an epoxy resin, a phenol resin, a novolac resin, an acrylic resin, a melamine resin, or a urethane resin may be used. Further, an organic material such as benzocyclobutene, fluorinated arylene ether, or polyimide; a composition material containing a water-soluble homopolymer and a water-soluble copolymer; or the like may be used. As a manufacturing method of the insulating layers 571 and 598, a vapor deposition method such as a plasma CVD method or a thermal CVD method, or a sputtering method can be used. Further, a droplet discharge method or a printing method (a method for forming a pattern, such as screen printing or offset printing) can be employed. A film obtained by a coating method, an SOG film, or the like may also be used.

The thin film transistor is not limited to the thin film transistor described in this embodiment mode, and may have a single gate structure with one channel formation region, a double gate structure with two channel formation regions, or a triple gate structure with channel formation regions. In addition, a thin film transistor in a peripheral driver circuit region may have a single gate structure, a double gate structure, or a triple gate structure.

Note that the method for manufacturing the thin film transistor described in this embodiment mode can also be applied to a top gate type (e.g., a coplanar type and a staggered type), a bottom gate type (e.g., an inverted coplanar type), a dual gate type having two gate electrode layers which are disposed above and below a channel formation region with the gate insulating film interposed therebetween, or other structure.

An electrode layer of a display element which is formed using a conductive composition containing a conductive polymer in this embodiment mode has an inorganic insulating film which blocks ionic impurities which contaminate a liquid crystal material or the like in a display layer, so that deterioration of the display layer is prevented. Therefore, a highly functional and highly reliable display device can be manufactured using such an electrode layer and an inorganic insulating film.

Further, since a wet process can be employed for manufacturing the electrode layer of the display element, efficiency in the use of materials can be high, and a cost reduction and a productivity improvement can be achieved because expensive facilities such as a large vacuum apparatus can be reduced. Therefore, a highly functional and highly reliable display device and electronic appliance can be manufactured in this embodiment mode according to the present invention.

This embodiment mode can be freely combined with Embodiment Mode 1.

### Embodiment Mode 3

This embodiment mode will describe an example of a display device aimed at higher image quality and higher reliability, which can be manufactured at low cost with high productivity. In specific, this embodiment mode describes a liquid crystal display device using a liquid crystal display element as a display element.

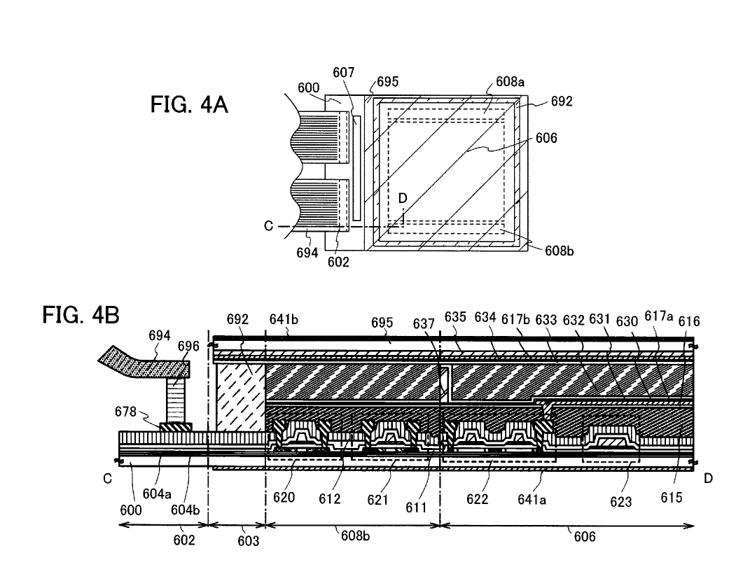

FIG. 4A is a top view of a liquid crystal display device which is one mode of the present invention. FIG. 4B is a cross-sectional view taken along line C-D in FIG. 4A.

As shown in FIG. 4A, a pixel region 606 and driver circuit regions 608a and 608b which are scan line driver circuits are sealed between a substrate 600 and a counter substrate 695 with a sealant 692. In addition, a driver circuit region 607 which is a signal line driver circuit including a driver IC is provided over the substrate 600. A transistor 622 and a capacitor 623 are provided in the pixel region 606, and a driver circuit including a transistor 620 and a transistor 621 is provided in the driver circuit region 608b. An insulating substrate can be used as the substrate 600 as in the above-described embodiment modes. Although there is a concern that a substrate formed of a synthetic resin generally has a low heat-resistance temperature compared to other kinds of substrates, the substrate formed of a synthetic resin can be employed by performing manufacturing steps using a substrate with high heat resistance and then replacing the substrate with the substrate formed of a synthetic resin.

In the pixel region 606, the transistor 622 serving as a switching element is provided over the substrate 600 with a base film 604a and a base film 604b interposed therebetween. In this embodiment mode, the transistor 622 is a multi-gate thin film transistor (TFT) and includes a semiconductor layer including impurity regions that serve as source and drain regions, a gate insulating layer, a gate electrode layer having a stacked structure of two layers, and source and drain electrode layers. The source or drain electrode layer is in contact with and is electrically connected to the impurity region in the semiconductor layer and an electrode layer 630 which is also referred to a pixel electrode layer of the display element.

The impurity region in the semiconductor layer can be formed as a high concentration impurity region or a low concentration impurity region by controlling the concentration. Such a thin film transistor having a low-concentration impurity region is referred to as a thin film transistor having a lightly doped drain (LDD) structure. The low-concentration impurity region can be formed so as to overlap with the gate electrode. Such a thin film transistor is referred to as a thin film transistor having a gate overlapped LDD (GOLD) structure. The polarity of the thin film transistor is set to be an n-type by using phosphorus (P) or the like in the impurity region. In the case where the polarity of the thin film transistor is a p-type, boron (B) or the like may be added. After that, insulating films 611 and 612 covering the gate electrode and the like are formed. A dangling bond in a crystalline semiconductor film can be terminated by hydrogen elements mixed in the insulating film 611 (and the insulating film 612).

In order to improve planarity, an insulating film 615 and an insulating film 616 may be formed as an interlayer insulating film. For the insulating films 615 and 616, an organic material, an inorganic material, or a laminate thereof can be used. For example, the insulating films 615 and 616 can be formed using a material selected from silicon oxide, silicon nitride, silicon oxynitride, silicon nitride oxide, aluminum nitride, aluminum oxynitride, aluminum nitride oxide which contains more nitrogen than oxygen, aluminum oxide, diamond-like carbon (DLC), polysilazane, carbon containing nitrogen (CN), phosphosilicate glass (PSG), borophosphosilicate glass (BPSG), alumina, and other substances including an inorganic insulating material. Alternatively, an organic insulating material may be used. As an organic material, either a photosensitive or non-photosensitive organic material may be used; for example, polyimide, acrylic, polyamide, polyimide amide, resist, benzocyclobutene, or a siloxane resin can be used. Note that a siloxane resin refers to a resin including a Si—O—Si bond. Siloxane has a skeletal structure formed of a bond of silicon (Si) and oxygen (O) and has an organic group containing at least hydrogen (e.g., an alkyl group or an aryl group) or a fluoro group as a substituent. Siloxane may have both an organic group containing at least hydrogen and a fluoro group as a substituent.

When a crystalline semiconductor film is used, a pixel region and a driver circuit region can be formed over the same substrate. In that case, a transistor in the pixel region and a transistor in the driver circuit region 608b are formed at the same time. The transistor used in the driver circuit region 608b forms a CMOS circuit. Although a thin film transistor included in a CMOS circuit has a GOLD structure, the transistor may have an LDD structure as the transistor 622 may be employed.

Then, an inorganic insulating film 617a serving as a barrier film is formed to cover the electrode layer 630 of the display element and the insulating film 616. An insulating layer 631 which is referred to as an alignment film is formed over the inorganic insulating film 617a by a printing method or a droplet discharge method. Note that the insulating layer 631 can be selectively formed when a screen printing method or an off-set printing method is used. Then, rubbing treatment is performed. This rubbing treatment is not necessarily performed when a certain mode of liquid crystal such as a VA mode is employed. An insulating layer 633 serving as an alignment film is similar to the insulating layer 631. Then, the sealant 692 is provided by a droplet discharge method in the periphery of the region where the pixels are formed.

After that, the counter substrate 695 provided with the insulating layer 633 serving as the alignment film, an inorganic insulating film 617b, an electrode layer 634 of the display element which is also referred to as a counter electrode, a color layer 635 serving as a color filter, and a polarizer (also referred to as a polarizing plate) 641b is attached to the substrate 600 which is a TFT substrate, with a spacer 637 interposed therebetween. A liquid crystal layer 632 is provided in the space between the substrates. Since the liquid crystal display device of this embodiment mode is a transmissive liquid crystal display device, a polarizer (polarizing plate) 641a is additionally provided on an opposite side of the substrate 600 from the elements. The stacked structure of the polarizer and the color layer is not limited to that shown in FIGS. 4A and 4B and may be determined as appropriate depending on materials or conditions of a manufacturing process of the polarizer and the color layer. The polarizer can be provided on the substrate with an adhesive layer. A filler may be mixed into the sealant, and a shielding film (black matrix) or the like may be formed on the counter substrate 695. Note that the color filter or the like may be formed of materials exhibiting red (R), green (G), and blue (B) when the liquid crystal display device performs full color display. When the liquid crystal display device performs monochrome display, the color layer may be omitted or formed of a material exhibiting at least one color. Further, an anti-reflection film having an anti-reflection function may be provided on the viewer side of the display device.

Note that when RGB light-emitting diodes (LEDs) and the like are located in a backlight and a field sequential method which conducts color display by time division is employed, a color filter is not provided in some cases. The black matrix is preferably provided to overlap with a transistor and a CMOS circuit in order to reduce reflection of external light by wirings of the transistor and the CMOS circuit. Note that the black matrix may be provided to overlap with the capacitor so that reflection by a metal film forming the capacitor can be prevented.

The liquid crystal layer can be formed by an injecting method by which liquid crystal is injected using a capillary action after the substrate 600 having elements and the counter substrate 695 are attached to each other, or a dispenser method (a dripping method). A dripping method may be employed when a large substrate to which an injecting method is difficult to be applied is used.

While the spacer may be provided by spraying particles having a size of several micrometers, the spacer in this embodiment mode is formed by a method in which a resin film is formed over the entire surface of the substrate and then etched. After coating the substrate with such a spacer material with a spinner, the spacer material is formed into a predetermined pattern by light exposure and developing treatment. Then, the material is baked at 150 to 200° C. with a clean oven or the like to be cured. Thus manufactured spacer can have various shapes depending on the conditions of light exposure and developing treatment. It is preferable that the spacer have a columnar shape with a flat top so that mechanical strength of the liquid crystal display device can be secured when the counter substrate is attached. The shape of the spacer can be a conical, pyramidal, or the like, and there is no particular limitation.

Then, a terminal electrode layer 678 electrically connected to the pixel region is connected to an FPC 694 which is a wiring board for connection through an anisotropic conductive layer 696. The FPC 694 transmits external signals or potential. Through the above-described steps, a liquid crystal display device having a display function can be manufactured.

The polarizing plate and the liquid crystal layer may be stacked with a retardation plate interposed therebetween.

FIGS. 4A and 4B show a transmissive liquid crystal display device which includes an electrode layer containing a light transmitting conductive polymer as the electrode layer 630 and the electrode layer 634. The inorganic insulating film 617a is provided between the electrode layer 630 and the insulating layer 631 serving as an alignment film. The inorganic insulating film 617b is provided between the electrode layer 634 and the insulating layer 633 serving as an alignment film. The inorganic insulating films 617a and 617b serves as barrier films which prevent ionic impurities from diffusing from the electrode layers 630 and 634.

The electrode layer containing a conductive polymer and an inorganic insulating film serving as a barrier film according to the present invention in this embodiment mode can be manufactured using the same material and by the same process in Embodiment Mode 1; accordingly, Embodiment Mode 1 can be applied to the formation of the electrode layer and the inorganic insulating film in this embodiment mode.

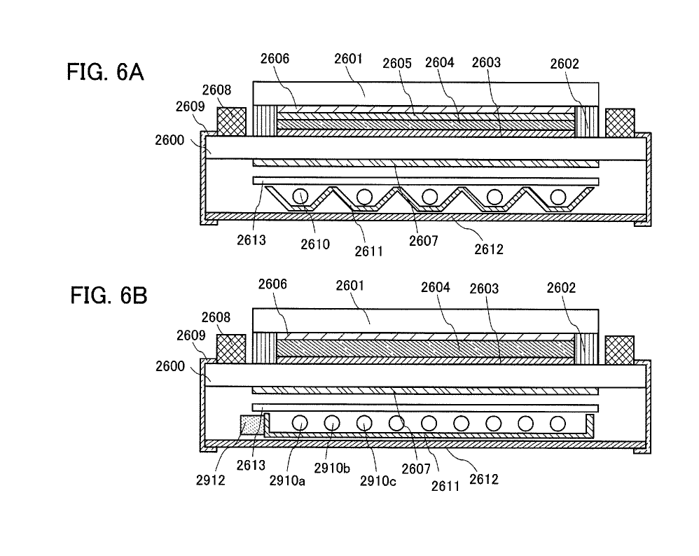

A liquid crystal display module can be manufactured using the display device in FIGS. 4A and 4B. FIGS. 6A and 6B show an example of a display device (a liquid crystal display module) using a TFT substrate 2600 that is manufactured according to the present invention.

FIG. 6A shows an example of a liquid crystal display module, in which the TFT substrate 2600 and a counter substrate 2601 are fixed to each other with a sealant 2602, and a pixel portion 2603 including a TFT and the like, a display element 2604 including a liquid crystal layer, a color layer 2605, and a polarizing plate 2606 are provided between the substrates to form a display region. The color layer 2605 is necessary to perform color display. In the case of the RGB system, color layers corresponding to colors of red, green, and blue are provided for pixels. The polarizing plate 2606 and a polarizing plate 2607, and a diffusion plate 2613 are outer than the TFT substrate 2600 and the counter substrate 2601. A light source includes a cold cathode fluorescent lamp 2610 and a reflective plate 2611. A circuit substrate 2612 is connected to a wiring circuit portion 2608 of the TFT substrate 2600 through a flexible wiring board 2609 and includes external circuits such as a control circuit and a power source circuit. The polarizing plate and the liquid crystal layer may be stacked with a retardation plate interposed therebetween.

The liquid crystal display module can employ a twisted nematic (TN) mode, an in-plane-switching (IPS) mode, a fringe field switching (FFS) mode, a multi-domain vertical alignment (MVA) mode, a patterned vertical alignment (PVA) mode, an axially symmetric aligned micro-cell (ASM) mode, an optical compensated birefringence (OCB) mode, a ferroelectric liquid crystal (FLC) mode, an anti ferroelectric liquid crystal (AFLC) mode, or the like.

FIG. 6B shows an example of a field sequential-LCD (FS-LCD) in which an OCB mode is applied to the liquid crystal display module in FIG. 6A. The FS-LCD performs red, green, and blue light emissions in one frame period. An image is produced by using time division so that color display can be performed. In addition, emission of each color is performed using a light emitting diode, a cold cathode fluorescent lamp, or the like; therefore, a color filter is not required. Accordingly, there is no necessity to arrange color filters of three primary colors and determine a display region of each color. Display of three colors can be performed in any region. On the other hand, since light of three colors is emitted in one frame period, high-speed response of liquid crystal is necessary. By applying an FLC mode using an FS system, and an OCB mode to a display device of the present invention, a display device or a liquid crystal television device with high performance and high image quality can be completed.

A liquid crystal layer of the OCB mode has a so-called π-cell structure. In the π-cell structure, liquid crystal molecules are aligned so that their pretilt angles are plane-symmetric with respect to a center plane between an active matrix substrate and a counter substrate. The orientation in the π-cell structure is a splay orientation when voltage is not applied between the substrates, and shifts into a bend orientation when voltage is applied. White display is performed with this bend orientation. When voltage is further applied, liquid crystal molecules of a bend orientation are orientated perpendicular to the both substrates so that light is not transmitted. Note that the response speed approximately ten times as high as that of a conventional TN mode can be achieved by employing the OCB mode.

Moreover, as a mode corresponding to the FS system, a half V-FLC (HV-FLC) or a surface stabilized-FLC (SS-FLC) using ferroelectric liquid crystal (FLC) capable of high-speed operation, or the like can also be used. The OCB mode uses nematic liquid crystal having relatively low viscosity, while HV-FLC or SS-FLC can use smectic liquid crystal having a ferroelectric phase.

An optical response speed of the liquid crystal display module is increased by narrowing a cell gap of the liquid crystal display module. The optical response speed can also be increased by lowering the viscosity of the liquid crystal material. The optical response speed can be further increased by an overdrive method in which applied voltage is increased (or decreased) only for a moment.

The liquid crystal display module in FIG. 6B is a transmissive liquid crystal display module, in which a red light source 2910a, a green light source 2910b, and a blue light source 2910c are provided as light sources. A control portion 2912 is provided to control the red light source 2910a, the green light source 2910b, and the blue light source 2910c to be turned on or off. The light emission of the colors is controlled by the control portion 2912 and light enters the liquid crystal to compose an image using a time division method, so that color display is performed.

An electrode layer of a display element which is formed using a conductive composition containing a conductive polymer in this embodiment mode has an inorganic insulating film which blocks ionic impurities which contaminate a liquid crystal material or the like in a display layer, so that deterioration of the display layer is prevented. Therefore, a highly functional and highly reliable display device can be manufactured using such an electrode layer and an inorganic insulating film.

Further, since a wet process can be employed for manufacturing the electrode layer of the display element, efficiency in the use of materials can be high, and a cost reduction and a productivity improvement can be achieved because expensive facilities such as a large vacuum apparatus can be reduced. Therefore, a highly functional and highly reliable display device and electronic appliance can be manufactured in this embodiment mode according to the present invention.

This embodiment mode can be freely combined with Embodiment Mode 1 or 2.

### Embodiment Mode 4

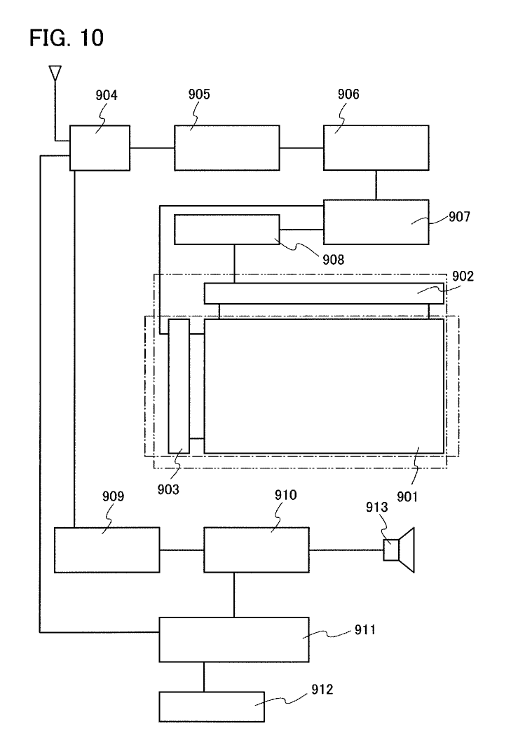

A television set (also referred to as a television simply or a television receiver) can be completed using a display device formed according to the present invention. FIG. 10 is a block diagram showing a main structure of a television device.

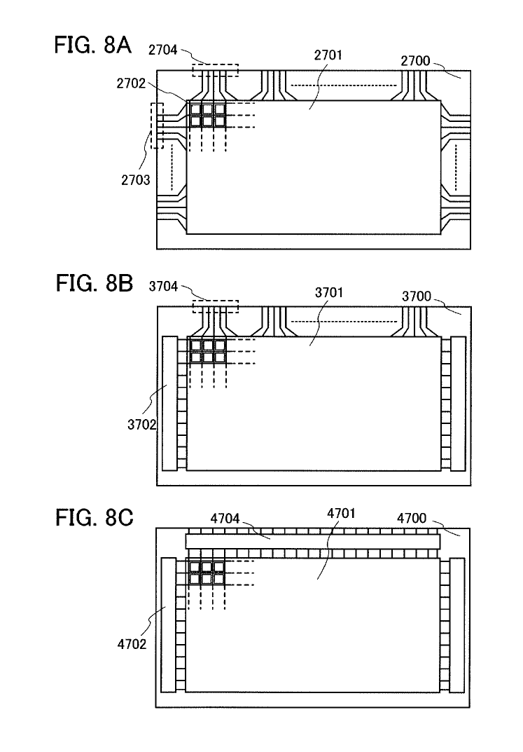

FIG. 8A is a top view showing a structure of a display panel according to the present invention, where a pixel portion 2701 in which pixels 2702 are arranged in matrix, a scanning line input terminal 2703, and a signal line input terminal 2704 are formed over a substrate 2700 having an insulating surface. The number of pixels may be determined according to various standards. In the case of XGA full-color display using RGB, the number of pixels may be 1024×768×3 (RGB). In the case of UXGA full-color display using RGB, the number of pixels may be 1600×1200×3 (RGB), and in the case of full-spec high-definition and full-color display using RGB, the number of pixels may be 1920×1080×3 (RGB).

The pixels 2702 are arranged in matrix by being provided at intersections of scanning lines extended from the scanning line input terminal 2703 and signal lines extended from the signal line input terminal 2704. Each pixel in the pixel portion 2701 is provided with a switching element and a pixel electrode layer of a display element connected thereto. A typical example of a switching element is a TFT. The TFT has a gate electrode layer side connected to the scanning line and a source or drain side connected to the signal line, so that each pixel can be controlled independently by a signal inputted from an external portion.

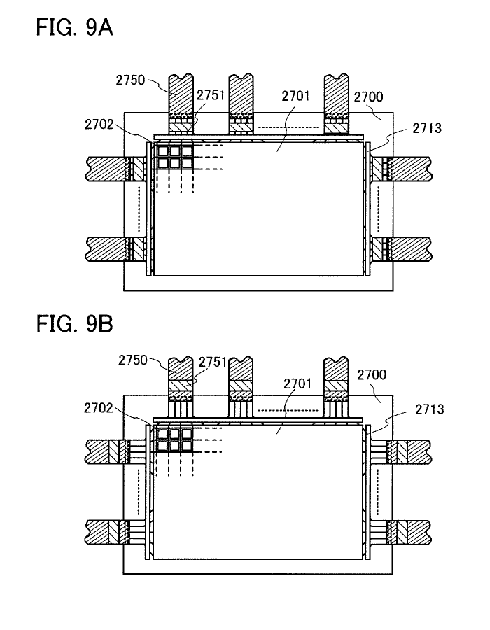

FIG. 8A shows a structure of a display panel in which signals inputted to the scan line and the signal line are controlled by an external driver circuit. A driver IC 2751 may be mounted on the substrate 2700 by a chip on glass (COG) method as shown in FIG. 9A. As another mounting mode, a tape automated bonding (TAB) method may be used as illustrated in FIG. 9B. The driver IC may be formed over a single crystal semiconductor substrate or may be formed of a TFT over a glass substrate. In FIGS. 9A and 9B, the driver IC 2751 is connected to a flexible printed circuit (FPC) 2750.

Further, in the case where a TFT provided in the pixel is formed using a semiconductor having crystallinity, a scanning line driver circuit 3702 can also be formed over a substrate 3700 as shown in FIG. 8B. In FIG. 8B, a pixel portion 3701 is controlled by an external driver circuit which is connected to a signal line input terminal 3704, as in FIG. 8A. In the case of forming a TFT provided in the pixels by using a polycrystalline (microcrystalline) semiconductor, a single crystal semiconductor, or the like which has high mobility, it is possible to form a pixel portion 4701, a scan line driver circuit 4702, and a signal line driver circuit 4704 over one substrate 4700 as shown in FIG. 8C.

As for the display panel, there are the following cases: the case shown in FIG. 8A in which only a pixel portion 901 is formed and a scan line driver circuit 903 and a signal line driver circuit 902 are mounted by a TAB method as shown in FIG. 9B or by a COG method as shown in FIG. 9A; the case shown in FIG. 8B in which a TFT is formed and the pixel portion 901 and the scan line driver circuit 903 are formed over a substrate, and the signal line driver circuit 902 is separately mounted as a driver IC; the case shown in FIG. 8C in which the pixel portion 901, the signal line driver circuit 902, and the scan line driver circuit 903 are formed over a substrate; and the like. The display panel may have any mode.

In FIG. 10, as other external circuits, a video signal amplifier circuit 905 that amplifies a video signal among signals received by a tuner 904, a video signal processing circuit 906 that converts the signals outputted from the video signal amplifier circuit 905 into chrominance signals corresponding to each color of red, green, and blue, a control circuit 907 that converts the video signal into the input specification of a driver IC, and the like are provided on an input side of the video signals. The control circuit 907 outputs signals to a scan line side and a signal line side. In the case of digital driving, a signal dividing circuit 908 may be provided on the signal line side and an input digital signal may be divided into m pieces to be supplied.

An audio signal among the signals received by the tuner 904 is transmitted to an audio signal amplifier circuit 909 and an output therefrom is supplied to a speaker 913 through an audio signal processing circuit 910. A control circuit 911 receives control information of a receiving station (reception frequency) or sound volume from an input portion 912 and transmits signals to the tuner 904 and the audio signal processing circuit 910.

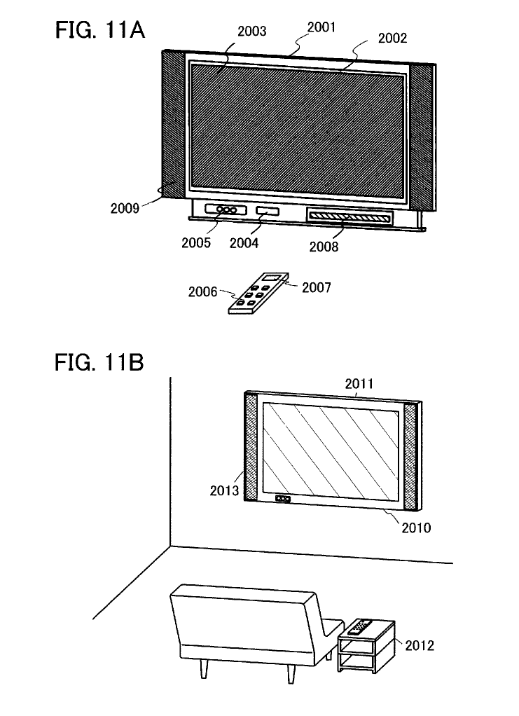

A television device can be completed by incorporating the above-described display module in a chassis as shown in FIGS. 11A and 11B. When a liquid crystal display module is used as a display module, a liquid crystal television device can be manufactured. In FIG. 11A, a main screen 2003 is formed by a display module, and a speaker portion 2009, an operation switch, and the like are provided as accessory equipment. Thus, a television device can be completed according to the present invention.

A display panel 2002 is incorporated into a chassis 2001. The television device can receive general TV broadcast by a receiver 2005 and further can be connected to a wired or wireless communication network via a modem 2004 so that one-way (from a sender to a receiver) or two-way (between a sender and a receiver or between receivers) information communication can be performed. The television device can be operated with a switch incorporated in the chassis or a separate remote control unit 2006. The remote control unit 2006 may have a display portion 2007 for displaying information to be outputted.

Further, the television device may include a sub screen 2008 including a second display panel to display channels, volume, or the like, in addition to the main screen 2003. In this structure, both the main screen 2003 and the sub screen 2008 can be formed using a liquid crystal display panel of the present invention. According to the present invention, a highly reliable display device can be formed even when a large-sized substrate is used and a large number of TFTs or electronic components are used.

FIG. 11B shows a television device having a large-sized display portion such as a 20 to 80-inch display portion. This television device includes a chassis 2010, a display portion 2011, a remote control unit 2012 which is an operation portion, a speaker portion 2013, and the like. The present invention is applied to manufacturing of the display portion 2011. The television device in FIG. 11B is a wall-hanging type, and does not require a large installation space. Since an electrode layer of a display element in the present invention can be formed by a wet process, even a television device with a large display portion as in FIGS. 11A and 11B can be manufactured at low cost and high productivity.

Needless to say, the present invention is not limited to television devices, and can be applied to various use applications as a large-sized display medium, such as an information display board at a train station, an airport, or the like, or an advertisement display board on the street, as well as a monitor of a personal computer.

This embodiment mode can be combined as appropriate with any of Embodiment Modes 1 to 3.

### Embodiment Mode 5

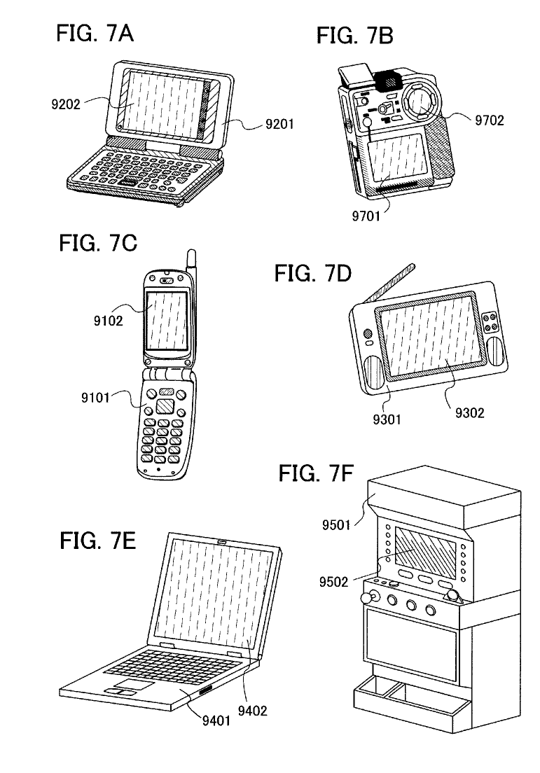

Examples of electronic appliances according to the present invention are as follows: a television set (also referred to as a television simply or a television receiver), a camera such as a digital camera or a digital video camera, a cellular telephone device (also simply referred to as a cellular phone or a cell-phone), an information terminal such as PDA, a portable game machine, a computer monitor, a computer, a sound reproducing device such as a car audio system, an image reproducing device including a recording medium, such as a home-use game machine, and the like. Further, the present invention can be applied to any game machine having a display device, such as a pachinko machine, a slot machine, a pinball machine, a large game machine, and the like. Specific examples are described with reference to FIGS. 7A to 7F.

A portable information terminal device shown in FIG. 7A has a main body 9201, a display portion 9202, and the like. A display device according to the present invention can be applied to the display portion 9202. As a result, a highly functional and highly reliable portable information terminal device on which high quality images with excellent visibility can be displayed can be provided.

A digital video camera shown in FIG. 7B has a display portion 9701, a display portion 9702, and the like. A display device according to the present invention can be applied to the display portion 9701. As a result, a highly functional and highly reliable digital video camera on which high quality images with excellent visibility can be displayed can be provided.

A cellular phone shown in FIG. 7C has a main body 9101, a display portion 9702, and the like. A display device according to the present invention can be applied to the display portion 9102. As a result, a highly functional and highly reliable cellular phone on which high quality images with excellent visibility can be displayed can be provided.

A portable television device shown in FIG. 7D has a main body 9301, a display portion 9302, and the like. A display device according to the present invention can be applied to the display portion 9302. As a result, a highly functional and highly reliable portable television device on which high quality images with excellent visibility can be displayed can be provided. Note that the display device of the present invention can be applied to a wide range of television devices ranging from a small-sized television device mounted on a portable terminal such as a cellular phone, a medium-sized television device which can be carried, to a large-sized (for example, equal to or larger than 40-inch) television device.

A portable computer shown in FIG. 7E has a main body 9401, a display portion 9402, and the like. A display device according to the present invention can be applied to the display portion 9402. As a result, a highly functional and highly reliable portable computer on which high quality images with excellent visibility can be displayed can be provided.

A slot machine shown in FIG. 7F has a main body 9501, a display portion 9502, and the like. A display device according to the present invention can be applied to the display portion 9502. As a result, a highly functional and highly reliable slot machine on which high quality images with excellent visibility can be displayed can be provided.

Further, a display device which uses a self-luminous display element (a light emitting display device) according to the present invention can be used as a light device. A display device to which the present invention is applied can be used as a small table lamp or a large lighting system in a room. Further, a light emitting display device of the present invention can also be used for a backlight of a liquid crystal display device. When the light emitting display device of the present invention is used as a backlight of a liquid crystal display device, the reliability of the liquid crystal display device can be improved. Further, the light emitting device of the present invention is a light device with plane light emission, and can have a large area. Therefore, the backlight can have a large area, which leads to increase in area of the liquid crystal display device. Further, since the light emitting display device of the present invention is thin, the liquid crystal display device can be made thin.

As described above, with a display device of the present invention, a highly functional and highly reliable electronic appliance on which high quality images with excellent visibility can be displayed can be provided.

This embodiment mode can be combined as appropriate with any of Embodiment Modes 1 to 4.

This application is based on Japanese Patent Application serial no. 2007-159178 filed with Japan Patent Office on Jun. 15, 2007, the entire contents of which are hereby incorporated by reference.

1. A display device comprising:
a display element comprising:
a first electrode layer comprising a conductive polymer;
a second electrode layer opposing to the first electrode layer;
a display layer provided between the first electrode layer and the second electrode layer; and
an inorganic insulating film provided between the first electrode layer and the display layer.

2. The display device according to claim 1,
wherein the first electrode layer and the inorganic insulating film are in contact with each other.

3. The display device according to claim 1,
wherein the inorganic insulating film is a silicon nitride film or a silicon nitride oxide film.

4. The display device according to claim 1,
wherein a thickness of the inorganic insulating film is equal to or greater than 5 nm, and is equal to or less than 500 nm.

5. The display device according to claim 1,
wherein the conductive polymer is selected from any one of polythiophene, polyaniline, polypyrrole, and a derivative thereof.

6. The display device according to claim 1,
wherein the first electrode layer further comprises an organic resin.

7. The display device according to claim 1,
wherein the first electrode layer further comprises one or plurality of any of a halogen, a Lewis acid, an inorganic acid, an organic acid, a halide of a transition metal, an organic cyano compound, and a nonionic surfactant as a dopant.

8. A display device comprising:
a display element comprising:
a first electrode layer comprising a conductive polymer;
a second electrode layer opposing to the first electrode layer;
a display layer provided between the first electrode layer and the second electrode layer; and
an inorganic insulating film provided between the first electrode layer and the display layer,
wherein the display layer is a liquid crystal layer.

9. The display device according to claim 8, further comprising:
an alignment film provided between the inorganic insulating film and the display layer.

10. The display device according to claim 8,
wherein the first electrode layer and the inorganic insulating film are in contact with each other.

11. The display device according to claim 8,
wherein the inorganic insulating film is a silicon nitride film or a silicon nitride oxide film.

12. The display device according to claim 8,
wherein a thickness of the inorganic insulating film is equal to or greater than 5 nm, and is equal to or less than 500 nm.

13. The display device according to claim 8,
wherein the conductive polymer is selected from any one of polythiophene, polyaniline, polypyrrole, and a derivative thereof.

14. The display device according to claim 8,
wherein the first electrode layer further comprises an organic resin.

15. The display device according to claim 8,
wherein the first electrode layer further comprises one or plurality of any of a halogen, a Lewis acid, an inorganic acid, an organic acid, a halide of a transition metal, an organic cyano compound, and a nonionic surfactant as a dopant.

16. A display device comprising:
a display element comprising:
a first electrode layer comprising a conductive polymer;
a second electrode layer comprising the conductive polymer, opposing to the first electrode layer;
a display layer provided between the first electrode layer and the second electrode layer;
a first inorganic insulating film provided between the first electrode layer and the display layer; and
a second inorganic insulating film provided between the second electrode layer and the display layer.

17. The display device according to claim 16,
wherein the first electrode layer and the first inorganic insulating film are in contact with each other, and
wherein the second electrode layer and the second inorganic insulating film are in contact with each other.

18. The display device according to claim 16,
wherein the first inorganic insulating film and the second inorganic insulating film are a silicon nitride film or a silicon nitride oxide film.

19. The display device according to claim 16,
wherein a thickness of each of the first inorganic insulating film and the second inorganic insulating film is equal to or greater than 5 nm, and is equal to or less than 500 nm.

20. The display device according to claim 16,
wherein the conductive polymer is selected from any one of polythiophene, polyaniline, polypyrrole, and a derivative thereof.

21. The display device according to claim 16,
wherein the first electrode layer further comprises an organic resin, and
wherein the second electrode layer further comprises the organic resin.

22. The display device according to claim 16,
wherein each of the first electrode layer and the second electrode layer further comprises one or plurality of any of a halogen, a Lewis acid, an inorganic acid, an organic acid, a halide of a transition metal, an organic cyano compound, and a nonionic surfactant as a dopant.

23. A display device comprising:
a display element comprising:
a first electrode layer comprising a conductive polymer;
a second electrode layer comprising the conductive polymer, opposing to the first electrode layer;
a display layer provided between the first electrode layer and the second electrode layer;
a first inorganic insulating film provided between the first electrode layer and the display layer; and
a second inorganic insulating film provided between the second electrode layer and the display layer.
wherein the display layer is a liquid crystal layer.

24. The display device according to claim 23, further comprising:
a first alignment film provided between the first inorganic insulating film and the display layer; and
a second alignment film provided between the second inorganic insulating film and the display layer.

25. The display device according to claim 23,
wherein the first electrode layer and the first inorganic insulating film are in contact with each other, and
wherein the second electrode layer and the second inorganic insulating film are in contact with each other.

26. The display device according to claim 23,
wherein the first inorganic insulating film and the second inorganic insulating film are a silicon nitride film or a silicon nitride oxide film.

27. The display device according to claim 23,
wherein a thickness of each of the first inorganic insulating film and the second inorganic insulating film is equal to or greater than 5 nm, and is equal to or less than 500 nm.

28. The display device according to claim 23,
wherein the conductive polymer is selected from any one of polythiophene, polyaniline, polypyrrole, and a derivative thereof.

29. The display device according to claim 23,
wherein the first electrode layer further comprises an organic resin, and
wherein the second electrode layer further comprises the organic resin.

30. The display device according to claim 23,
wherein each of the first electrode layer and the second electrode layer further comprises one or plurality of any of a halogen, a Lewis acid, an inorganic acid, an organic acid, a halide of a transition metal, an organic cyano compound, and a nonionic surfactant as a dopant.

31. An electronic appliance comprising the display device according to claim 1, wherein the electronic appliance is one selected from the group consisting of a television device, a portable information terminal device, a digital video camera, a cellular phone, a portable television device, a portable computer, a slot machine.

32. An electronic appliance comprising the display device according to claim 8, wherein the electronic appliance is one selected from the group consisting of a television device, a portable information terminal device, a digital video camera, a cellular phone, a portable television device, a portable computer, a slot machine.

33. An electronic appliance comprising the display device according to claim 16, wherein the electronic appliance is one selected from the group consisting of a television device, a portable information terminal device, a digital video camera, a cellular phone, a portable television device, a portable computer, a slot machine.

34. An electronic appliance comprising the display device according to claim 23, wherein the electronic appliance is one selected from the group consisting of a television device, a portable information terminal device, a digital video camera, a cellular phone, a portable television device, a portable computer, a slot machine.
